(19) United States
(12) Patent Application Publication
(10) Pub. No.: US 2015/0193668 A1
(43) Pub. Date: Jul. 9, 2015

(54) INFORMATION PROCESSING APPARATUS, STORE SYSTEM AND METHOD FOR RECOGNIZING OBJECT

(71) Applicant: TOSHIBA TEC KABUSHIKI KAISHA, Tokyo (JP)

(72) Inventor: Masatsugu Fukuda, Kannami Tagata Shizuoka (JP)

(21) Appl. No.: 14/589,331

(22) Filed: Jan. 5, 2015

(30) Foreign Application Priority Data
Jan. 7, 2014 (JP) 2014-001171

(51) Int. Cl. G06K 9/32; G06Q 20/20; G06K 9/62

(52) U.S. Cl. CPC G06K 9/3208; G06K 9/6202; G06Q 20/208

(57) ABSTRACT

In accordance with one embodiment, an information processing apparatus comprises a selection module configured to select a target object from a storage section in which feature amounts for recognizing an object are stored for a plurality of objects; an image capturing module configured to photograph an object held to the image capturing module to capture an image of the object; a recognition module configured to compare the feature amount of the object stored in the storage section with the feature amount of the object contained in the image captured by the image capturing module to recognize the object; a determination module configured to determine the propriety of a holding manner of the object according to the ranking of the object selected by the selection module in the recognition result of the recognition module; and a notification module configured to notify a determination result of the determination module.

### CROSS-REFERENCE TO RELATED APPLICATION

This application is based upon and claims the benefit of priority from Japanese Patent Application No. 2014-001171, filed Jan. 7, 2014, the entire contents of which are incorporated herein by reference.

### FIELD

Embodiments described herein relate generally to an information processing apparatus, a store system and method for recognizing an object by the information processing apparatus.

### BACKGROUND

Conventionally, there is a general object recognition technology in which feature amount of a target object extracted from an image data obtained by photographing the object with an image sensor device is compared with a prepared reference data (feature amount) stored in a dictionary to obtain a similarity degree, and the category and the like of the object is recognized (detected) according to the similarity degree. Moreover, a store system in which such a general object recognition technology is applied to the recognition of a commodity such as vegetables and fruits and the sales of the recognized commodity is registered has been proposed.

In the general object recognition described above, the image data obtained by photographing the commodity varies according to the holding manner of the commodity such as the surface of the commodity oriented to a reading window (image sensor device), the position of the commodity, the distance between the image sensor device and the commodity, and the like.

Accordingly, there is a possibility that the commodity cannot be recognized due to an improper holding manner of the commodity by an operator.

### BRIEF DESCRIPTION OF THE DRAWINGS

FIG. 1 is a perspective view illustrating an example of a checkout system according to one embodiment;

FIG. 2 is a block diagram illustrating the hardware constitution of a POS terminal and a commodity reading apparatus;

FIG. 3 is a conceptual diagram illustrating an example of the data constitution of a PLU file;

FIG. 4 is a block diagram illustrating the functional components of the POS terminal;

FIG. 5 is a diagram illustrating an example of a frame image acquired by an image acquisition section;

FIG. 6 is a diagram illustrating an example of a determination screen;

FIG. 7 is a diagram illustrating an example of a confirmation screen;

FIG. 8 is a diagram illustrating an example of a screen on which illustration images of commodity candidates are displayed;

FIG. 9 is a flowchart illustrating a real-time recognition determination processing executed by the checkout system;

FIG. 10 is a diagram illustrating an example of an accuracy check screen;

FIG. 11 is a diagram illustrating an example of a high recognition result screen;

FIG. 12 is a diagram illustrating an example of a medium recognition result screen;

FIG. 13 is a diagram illustrating an example of a low recognition result screen;

FIG. 14 is a diagram illustrating an example of a stop execution screen;

FIG. 15 is a perspective view illustrating the external constitution of a self-checkout POS terminal; and

FIG. 16 is a block diagram illustrating the hardware constitution of the self-checkout POS terminal.

### DETAILED DESCRIPTION

In accordance with one embodiment, an information processing apparatus comprises a selection module configured to select a target object from a storage section in which feature amounts for recognizing an object are stored for a plurality of objects; an image capturing module configured to photograph an object held to the image capturing module to capture an image of the object; a recognition module configured to compare the feature amount of the object stored in the storage section with the feature amount of the object contained in the image captured by the image capturing module to recognize the object photographed by the image capturing module; a determination module configured to determine the propriety of a holding manner of the object according to the ranking of the object selected by the selection module in the recognition result of the recognition module; and a notification module configured to notify a determination result of the determination module.

Hereinafter, the information processing apparatus, the store system and the object recognition method according to the present embodiment are described with reference to the accompanying drawings by taking a checkout system as an example. The store system is a checkout system (POS system) and the like equipped with a POS terminal for registering commodities and carrying out the settlement in one transaction. The present embodiment is an example of application to a checkout system introduced to a store such as a supermarket and the like.

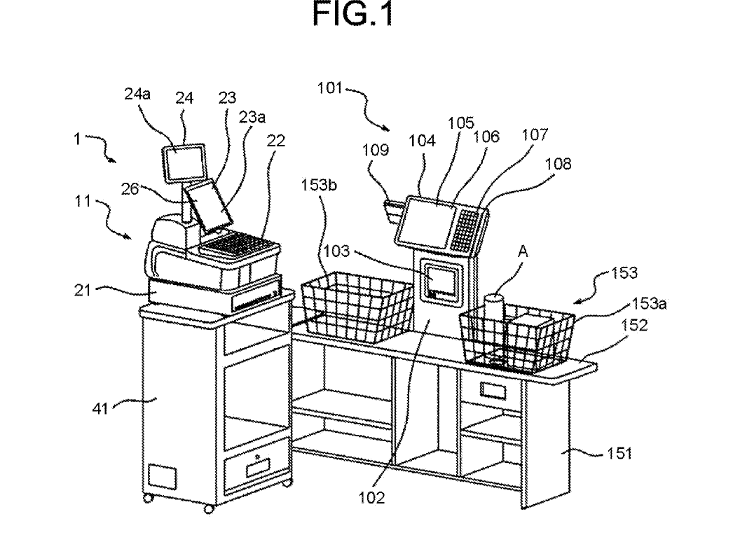

FIG. 1 is a perspective view illustrating an example of a checkout system 1 according to the embodiment. As shown in FIG. 1, the checkout system 1 includes a commodity reading apparatus 101 for reading information relating to a commodity and a POS terminal 11 for registering commodities and carrying out the settlement in one transaction. Hereinafter, an example in which the POS terminal 11 is applied as the information processing apparatus according to the present embodiment is described.

The POS terminal 11 is placed on a drawer 21 on a checkout counter (register table) 41. The drawer 21 is opened or closed under the control of the POS terminal 11. The POS terminal 11 is equipped with a keyboard 22, a display device 23 and a display for customer 24. The keyboard 22 is arranged on the upper surface of the POS terminal 11 for an operator (shop clerk) who operates the POS terminal 11. The display device 23 for displaying information to the operator is arranged at a position opposite to the operator with respect to the keyboard 22. The display device 23 displays information on a display screen 23a thereof. A touch panel 26 is laminated on the display screen 23a. The display for customer 24 is vertically arranged to be rotatable at a backside to the display device 23. The display for customer 24 displays information on a display screen 24a thereof. The display for customer 24 shown in FIG. 1 is in a state in which the display screen 24a thereof faces the operator in FIG. 1, however, the display for customer 24 can be rotated such that the display screen 24a is directed to a customer who stands across a counter table 151 to display information to the customer.

The counter table 151 is formed in horizontally elongated shape along a customer passage and is arranged to be in an L-shape with the checkout counter 41 on which the POS terminal 11 is placed. A commodity receiving surface 152 is formed on the counter table 151. Shopping basket 153 which receives a commodity A therein is placed on the commodity receiving surface 152. It can be understood to classify the shopping basket 153 on the counter table 151 into a first shopping basket 153a brought to the counter table 151 by a customer and a second shopping basket 153b placed facing the first shopping basket 153a across the commodity reading apparatus 101. The shopping basket 153, which is not limited to a so-called basket shape, may be a tray and the like. Further, the shopping basket 153 (second shopping basket 153b), which is not limited to a so-called basket shape, may be a box, a bag and the like.

The commodity reading apparatus 101, which is connected with the POS terminal 11 to be capable of sending and receiving data, is arranged on the commodity receiving surface 152 of the counter table 151. The commodity reading apparatus 101 comprises a thin rectangular housing 102 vertically arranged on the counter table 151. A reading window 103 is arranged at the front side of the housing 102. A display and operation section 104 is installed on the upper portion of the housing 102. A display device 106 serving as a display device on the surface of which a touch panel 105 is laminated is arranged on the display and operation section 104. A keyboard 107 is arranged at the right side of the display device 106. A card scanning slot 108 of a card reader (not shown) is arranged at the right side of the keyboard 107. A display for customer 109 for providing information for a customer is arranged at the left side of the display and operation section 104.

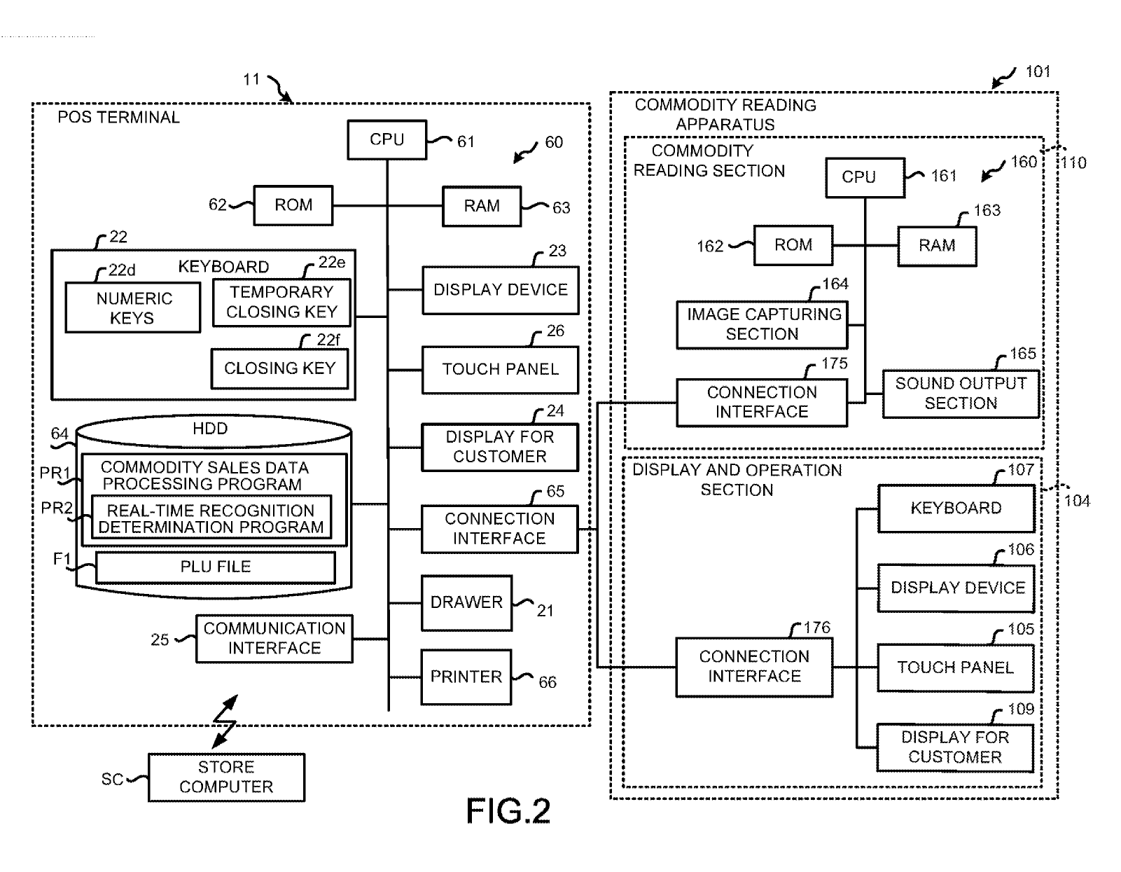

Such a commodity reading apparatus 101 includes a commodity reading section 110 (refer to FIG. 2). The commodity reading section 110 is equipped with an image capturing section 164 (refer to FIG. 2) at the rear side of the reading window 103.

Commodities A purchased in one transaction are put in the first shopping basket 153a and are brought to the counter table 151 by a customer. The commodities A in the first shopping basket 153a are moved one by one to the second shopping basket 153b by the operator who operates the commodity reading apparatus 101. During the movement, the commodity A is directed to the reading window 103 of the commodity reading apparatus 101. At this time, an image capturing section 164 (referring to FIG. 2) arranged in the housing 102 captures an image of the commodity A through the reading window 103.

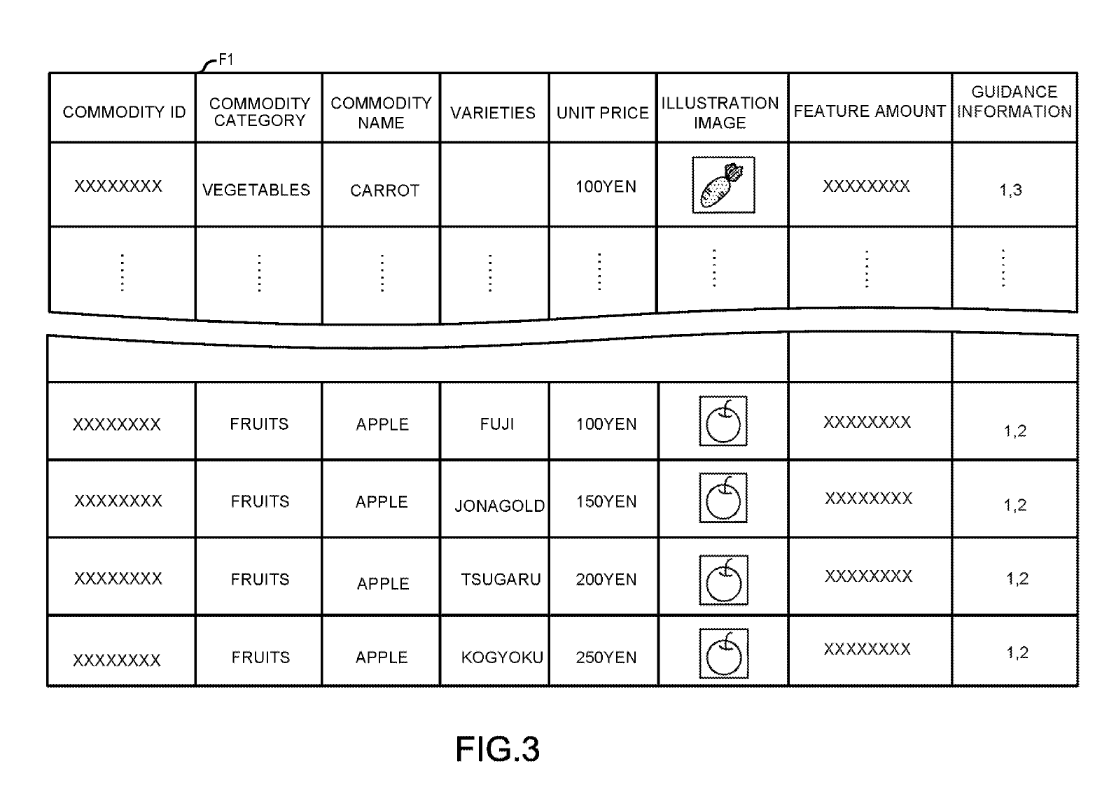

In the commodity reading apparatus 101, a screen for designating a commodity registered in a later-described PLU file F1 (refer to FIG. 3) corresponding to the commodity A contained in an image captured by the image capturing section 164 is displayed on the display and operation section 104, and a commodity ID of the designated commodity is notified to the POS terminal 11. In the POS terminal 11, information relating to the sales registration of the commodity category, commodity name, unit price and the like of the commodity specified with the commodity ID is recorded in a sales master file (not shown) based on the commodity ID notified from the commodity reading apparatus 101 to carry out sales registration.

FIG. 2 is a block diagram illustrating the hardware constitution of the POS terminal 11 and the commodity reading apparatus 101. The POS terminal 11 includes a microcomputer 60 serving as an information processing section for executing the information processing. The microcomputer 60 is constituted by connecting a ROM (Read Only Memory) 62 and a RAM (Random Access Memory) 63 with a CPU (Central Processing Unit) 61 which executes various kinds of arithmetic processing to control each section of the POS terminal 11 through a bus line.

The drawer 21, the keyboard 22, the display device 23, the touch panel 26 and the display for customer 24 are all connected with the CPU 61 of the POS terminal 11 via various input/output circuits (none is shown). These sections are controlled by the CPU 61.

The keyboard 22 includes numeric keys 22d on which numeric characters such as ‘1’, ‘2’, ‘3’ . . . and operators such as multiplying operator ‘*’ are displayed, a temporary closing key 22e and a closing key 22f.

An HDD (Hard Disk Drive) 64 is connected with the CPU 61 of the POS terminal 11. The HDD 64 stores programs and various files. When the POS terminal 11 is started, the programs and the various files stored in the HDD 64 are all or partially developed or copied on the RAM 63 to be executed by the CPU 61. The programs stored in the HDD 64 include, for example, a commodity sales data processing program PR1 and a real-time recognition determination program PR2. The files stored in the HDD 64 include, for example, a PLU file F1 sent from a store computer SC.

The PLU file F1 is a commodity file in which the information relating to the sales registration of the commodity A is stored for each of the commodities A displayed and sold in the store. In the following description, the PLU file F1 is used as a dictionary, however, the dictionary may be a file different from the PLU file F1. The dictionary stores, for a plurality of commodities, the reference data (feature amount) used to recognize the commodity extracted from the image data obtained from a captured image. In a case in which the dictionary is a file different from the PLU file F1, the reference data (feature amount) stored in the dictionary is associated with the information (recognition information) stored in the PLU file F1. The feature amount is obtained by parameterizing the appearance feature such as the standard shape, surface tint, pattern, concave-convex state and the like of the commodity.

FIG. 3 is a conceptual diagram illustrating an example of the data arrangement of the PLU file F1. As shown in FIG. 3, information relating to a commodity such as a commodity ID serving as recognition information uniquely assigned to each commodity A, a commodity category the commodity A belongs to, a commodity name, a variety, a unit price and the like, an illustration image indicating the commodity A, and the feature amount such as the tint, the surface concave-convex state and the like read from the captured commodity image, for each commodity A are stored in the PLU file F1 as the commodity information of the commodity A. Further, the feature amount is the reference data used in the later-described similarity degree determination. The PLU file F1 can be read by the commodity reading apparatus 101 through a later-described connection interface 65.

In addition, as shown in FIG. 3, the PLU file F1 further stores guidance information for each commodity. The guidance information displays the guidance indicating an important point or matters to be attended to for each feature of an object (commodity A) photographed by the image capturing section 164 when the commodity A is held over the image capturing section 164.

For example, the following guidance is given as the guidance display indicating the important point for each feature of a commodity to be photographed.

1. Guidance indicating an image capturing distance to the image capturing section 164 commonly applied, for all commodities to be photographed.

2. Guidance guiding to photograph the entire object while turning the object around, for a spherical object such as an apple and the like.

3. Guidance guiding to photograph the entire object to obtain an image in a longitudinal direction of the object while turning the object around by taking the longitudinal direction as an axis, for a long object such as a white radish, leek and the like.

4. Guidance guiding to photograph an object in such a manner that the hand of a shop clerk holding the object is not imaged in an image captured by the image capturing section 164, for a small object such as a citrus sudachi and the like.

1 and 3 are set as the guidance information for an object “carrot” shown at the top of FIG. 3.

Returning to FIG. 2, the communication interface 25 for executing data communication with a store computer SC is connected with the CPU 61 of the POS terminal 11 through the input/output circuit (not shown). The store computer SC is arranged at a back office and the like in a store. The HDD (not shown) of the store computer SC stores the PLU file F1 to be delivered to the POS terminal 11.

The connection interface 65 which enables the data transmission/reception with the commodity reading apparatus 101 is connected with the CPU 61 of the POS terminal 11. The commodity reading apparatus 101 is connected with the connection interface 65. A receipt printer 66 which carries out printing on a receipt and the like is connected with the CPU 61 of the POS terminal 11. The POS terminal 11 prints content of one transaction on a receipt under the control of the CPU 61.

The commodity reading section 110 of the commodity reading apparatus 101 also includes a microcomputer 160. The microcomputer 160 is constituted by connecting a ROM 162 and a RAM 163 with a CPU 161 through a bus line. The ROM 162 stores programs executed by the CPU 161. The image capturing section 164 and a sound output section 165 are connected with the CPU 161 through various input/output circuits (not shown). The operations of the image capturing section 164 and the sound output section 165 are controlled by the CPU 161. The display and operation section 104 is connected with the commodity reading section 110 and the POS terminal 11 through a connection interface 176. The operation of the display and operation section 104 is controlled by the CPU 161 of the commodity reading section 110 and the CPU 61 of the POS terminal 11.

The image capturing section 164, which is a color CCD image sensor or a color CMOS image sensor and the like, is an image capturing module for carrying out an image capturing processing through the reading window 103 under the control of the CPU 161. For example, images are captured by the image capturing section 164 at 30 fps (Flame Per Second). The frame images (captured images) sequentially captured by the image capturing section 164 at a predetermined frame rate are stored in the RAM 163. That is, the image capturing section 164 photographs the commodity A held by the shop clerk.

The sound output section 165 includes a sound circuit and a speaker and the like for issuing a preset alarm sound and the like. The sound output section 165 gives a notification with a voice or an alarm sound under the control of the CPU 161.

Further, a connection interface 175, which is connected with the connection interface 65 of the POS terminal 11 and enables the data transmission/reception with the POS terminal 11, is connected with the CPU 161. The CPU 161 carries out data transmission/reception with the display and operation section 104 through the connection interface 175.

Next, the functional components of the CPU 61 realized by executing programs (commodity sales data processing program PR1 and real-time recognition determination program PR2) by the CPU 61 are described below.

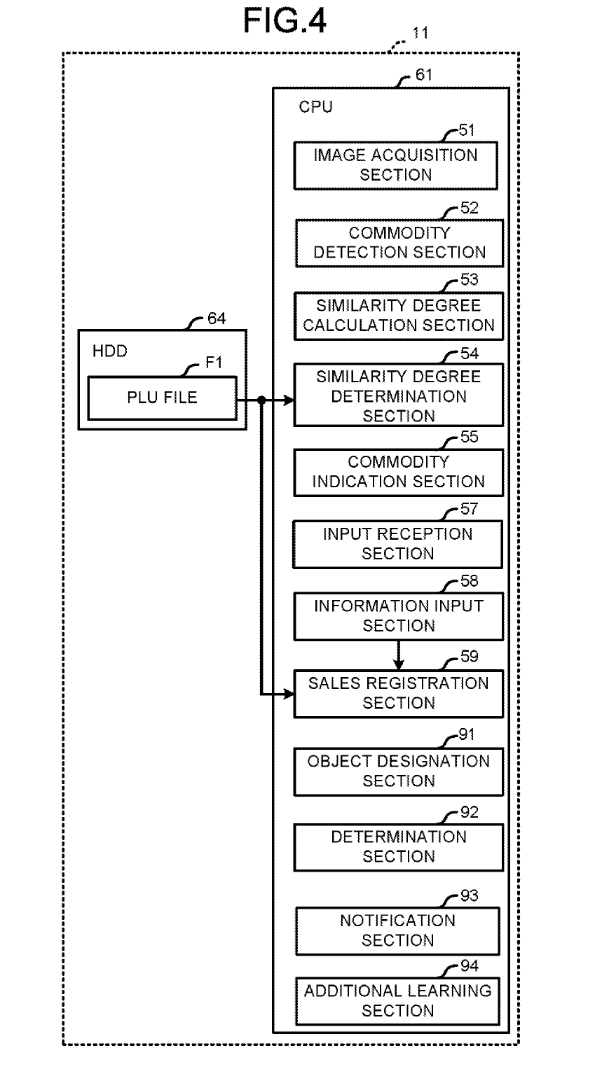

FIG. 4 is a block diagram illustrating the functional components of the POS terminal 11. As shown in FIG. 4, the CPU 61 of the POS terminal 11 executes the commodity sales data processing program PR1 and the real-time recognition determination program PR2 to function as an image acquisition section 51, a commodity detection section 52, a similarity degree calculation section 53, a similarity degree determination section 54, a commodity indication section 55, an input reception section 57, an information input section 58, a sales registration section 59 serving as a sales registration processing module, an object designation section 91, a determination section 92, a notification section 93 and an additional learning section 94.

(Commodity Registration Processing and Sales Registration Processing)

First, the commodity registration processing according to the general object recognition by the image acquisition section 51, the commodity detection section 52, the similarity degree calculation section 53, the similarity degree determination section 54, the commodity indication section 55, the input reception section 57 and the information input section 58 of the POS terminal 11 and the sales registration processing by the sales registration section 59 are described schematically.

The image acquisition section 51 outputs an ON-signal of image capturing to the image capturing section 164 to enable the image capturing section 164 to start an image capturing operation. The image acquisition section 51 sequentially acquires the frame images which are captured and stored in the RAM 163 by the image capturing section 164 after the image capturing operation is started. The image acquisition section 51 acquires the frame images from the RAM 163 in the order the same as that of storing them to the RAM 163.

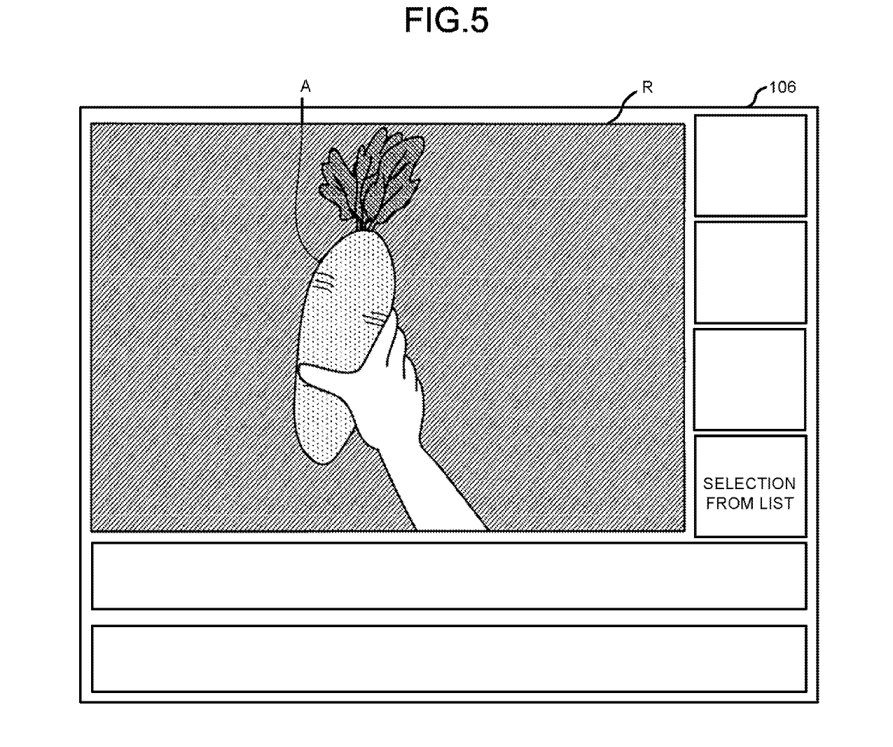

FIG. 5 is a diagram illustrating an example of a frame image acquired by the image acquisition section 51. As shown in FIG. 5, when an operator holds the commodity A over the reading window 103, the entire or part of the commodity A is photographed in a reading area R of the image capturing section 164 and displayed on the display device 106 of the commodity reading apparatus 101.

The commodity detection section 52 detects the commodity A contained in the frame image, which is captured by the image capturing section 164 and acquired by the image acquisition section 51, to extract the feature amount thereof. The commodity detection section 52 detects the whole or part of the commodity A contained in the frame image through a known pattern matching technology to extract the feature amount of the photographed commodity A. Specifically, the commodity detection section 52 extracts a contour line and the like from the binary image of the acquired frame image. Next, the contour line extracted from the last time frame image is compared with the contour line extracted from the this time frame image to detect the commodity A which is held over the reading window 103 for the sales registration.

As another method for detecting a commodity A, it is detected whether or not there is a flesh color area in the acquired frame image. If the flesh color area is detected, in other words, if the hand of a shop clerk (operator) is detected, the aforementioned detection of the contour line nearby the flesh color area is carried out to try to extract the contour line of the commodity that is assumed to be held by the shop clerk. At this time, if a contour line representing the shape of a hand and the contour line of another object nearby the contour line of the hand are detected, the commodity detection section 52 detects the commodity A from the contour line of the object.

Further, the commodity detection section 52 reads the surface state such as the tint, the surface concave-convex state and the like of the commodity A from the whole or part of the image of the detected commodity A as the feature amount thereof. In addition, to shorten the processing time, the commodity detection section 52 does not take the contour or the size of the commodity A into consideration.

The similarity degree calculation section 53 respectively compares the feature amount indicating the surface state such as the tint, the surface concave-convex state and the like of the commodity image of each commodity (hereinafter referred to as a “registered commodity”) registered in the PLU file F1 with the feature amount of the commodity A extracted by the commodity detection section 52 to calculate a similarity degree between the commodity A and the registered commodity in the PLU file F1. In a case in which the commodity image at the time of commodity registration of each commodity stored in the PLU file F1 is set to “similarity degree: 1.0”=100%, the similarity degree indicates how similar the whole or part of the image of the commodity A is to the registered commodity image. For example, in the tint and the surface concave-convex state, the weightings on them are respectively changed to calculate the similarity degree.

The recognition of an object contained in an image as stated above is referred to as general object recognition. As to the general object recognition, various recognition technologies are described in the following document.

Keiji Yanai “Present situation and future of generic object recognition”, Journal of Information Processing Society, Vol. 48, No. SIG16 [Search on Heisei 22 August 10th], Internet <URL: http://mm.cs.uec.ac.jp/IPSJ-TCVIM-Yanai.pdf>

In addition, the technology carrying out the general object recognition by performing an area-division on the image for each object is described in the following document.

Jamie Shotton etc, “Semantic Texton Forests for Image Categorization and Segmentation”, [Search on Heisei 22 August 10th], Internet <URL: http://citeseerx.ist.psu.edu/viewdoc/download?doi=10.1.1.14 5.3036&rep=rep1&type=pdf>

It is noted that no limitation is given to the method for calculating the similarity degree between the image of the photographed commodity A and the registered commodity in the PLU file F1. For example, the similarity degree between the image of the photographed commodity A and each registered commodity in the PLU file F1 can be calculated as an absolute evaluation or a relative evaluation.

If the similarity degree is calculated as an absolute evaluation, the image of the photographed commodity A and each registered commodity in the PLU file F1 are compared one by one, and the similarity degree obtained from the comparison result can be adopted as it is. In a case in which the similarity degree is calculated as a relative evaluation, if five commodities (commodities AA, AB, AC, AD and AE) are registered in the PLU file F1, the similarity degree is obtained as long as the sum of the similarity degrees between the captured commodity A and each registered commodity becomes 1.0 (100%) ; for example, the similarity degree between the photographed commodity A and the commodity AA is 0.6, the similarity degree between the photographed commodity A and the commodity AB is 0.1, the similarity degree between the photographed commodity A and the commodity AC is 0.1, the similarity degree between the photographed commodity A and the commodity AD is 0.1, and the similarity degree between the photographed commodity A and the commodity AE is 0.1.

The similarity degree determination section 54 compares the similarity degrees between the image of the commodity A and the registered commodities in the PLU file F1 for each frame image acquired by the image acquisition section 51. In the present embodiment, a plurality of conditions are set in stages for the similarity degrees between the image of the commodity A and the images of the registered commodities, and the similarity degree determination section 54 determines the registered commodity or selects a candidate of the commodity according to the condition that is met. No specific limitation is given to the conditions relating to the similarity degree, and a case in which conditions a˜d are used is described below.

Herein, the condition a and the condition b, which are a first condition according to the present embodiment, are used to determine one commodity within the registered commodities in the PLU file F1 as the commodity A photographed by the image capturing section 164. The condition c, which is a second condition according to the present embodiment, is used to extract candidates of the commodity A photographed by the image capturing section 164 in a case in which there are no multiple objects of different varieties belonging to the same category (commodity) within the registered commodities in the PLU file F1. The condition d, which is a third condition according to the present embodiment, is used to extract a candidate of the commodity A photographed by the image capturing section 164 in a case in which there are multiple objects of different varieties belonging to the same category (commodity) within the candidates of the commodity A meeting the condition c.

The similarity degree determination section 54 determines (confirms) that the registered commodity meeting the condition a or the condition b is a commodity (hereinafter referred to as a “determined commodity”) corresponding one-to-one to the commodity A photographed by the image capturing section 164. The similarity degree determination section 54 determines that the registered commodity meeting the condition c is not a determined commodity but a candidate (hereinafter referred to as a “commodity candidate”) of the commodity A photographed by the image capturing section 164. Then the registered commodity meeting the condition c is extracted from the plurality of registered commodities in the PLU file F1 to extract the commodity candidate of the commodity A.

Further, the similarity degree determination section 54 determines that the registered commodities (objects of different varieties belonging to the same commodity category) meeting the condition d are not the determined commodity but the candidates of the commodity A photographed by the image capturing section 164. Then the registered commodities meeting the condition d are extracted from the plurality of registered commodities in the PLU file F1 to extract the commodity candidates of the commodity A.

No specific limitation is given to the details of the conditions a˜c as long as the conditions are set in stages respectively corresponding to the similarity degrees. For example, the conditions a˜c may be set according to a plurality of preset threshold values. Herein, it is exemplified that the conditions a˜c are set according to a first threshold value˜third threshold value. In addition, the first˜third threshold values meet the following relation: first threshold value>second threshold value>third threshold value.

The similarity degree determination section 54 counts the number of times the similarity degree between the commodity A and the registered commodity is greater than the predetermined first threshold value (for example, 90%), and determines that the condition a is met if the number of times is greater than a predetermined number of times. In a case in which the first threshold value is set high enough so that no error determination occurs, the predetermined number of times may be set to one to determine whether or not the condition a is met.

The similarity degree determination section 54 determines that the condition b is met if the similarity degree between the commodity A and the registered commodity is smaller than the first threshold value (for example, 90%) and greater than the second threshold value (for example, 75%) which is smaller than the first threshold value. It is determined that the registered commodity meeting the condition b is a determined commodity, but it needs to be confirmed by an operator. Further, it is also applicable to count the number of times the similarity degree between the commodity A and the registered commodity is smaller than the first threshold value (for example, 90%) and greater than the second threshold value (for example, 75%) smaller than the first threshold value, and determine that the condition b is met if the number of times counted is greater than a predetermined number of times.

The similarity degree determination section 54 determines that the condition c is met if the similarity degree between the commodity A and the registered commodity is smaller than the second threshold value (for example, 75%) and greater than the third threshold value (for example, 10%) which is smaller than the second threshold value. Further, it is also applicable to count the number of times the similarity degree between the commodity A and the registered commodity is smaller than the second threshold value (for example, 75%) and greater than the third threshold value (for example, 10%) smaller than the second threshold value, and determine that the condition c is met if the number of times counted is greater than a predetermined number of times.

Each of the conditions a˜c, which is not limited to the example described above, may be properly set according to the magnitude of the similarity degree, the number of determination times and the like. The predetermined number of times used in the determination of the conditions a˜c may be set to be different for each condition.

In a case in which there are a plurality of objects of different varieties belonging to the same commodity category within the registered commodities meeting the condition c, the similarity degree determination section 54 sums the similarity degrees of the plurality of the different varieties, and determines that the condition d is met if the sum of the similarity degrees of the different varieties in the same commodity category is greater than the predetermined second threshold value (for example, 75%).

Further, the similarity degree determination section 54 creates a ranking in which the registered commodities are ranked in the magnitude of similarity degree.

The commodity indication section 55 notifies, through an image output or sound output and the like, the operator or the customer that it is uniquely confirmed that the commodity photographed by the image capturing section 164 is the registered commodity meeting the condition a or the condition b.

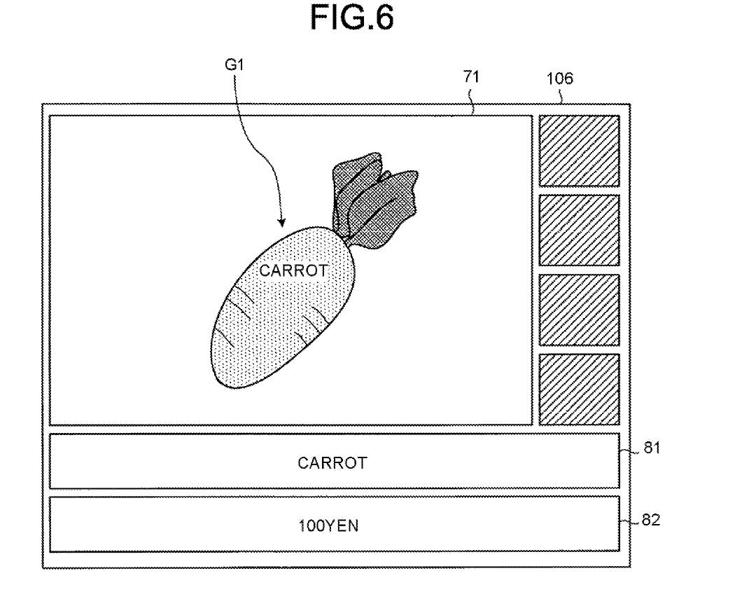

More specifically, the commodity indication section 55 displays, on the display device 106, a determination screen 71 (refer to FIG. 6) indicating that the registered commodity meeting the condition a is uniquely determined as a commodity (determined commodity) photographed by the image capturing section 164.

FIG. 6 is a diagram illustrating an example of the determination screen 71. If there is a registered commodity meeting the condition a, the commodity indication section 55 stops displaying the captured image in the reading area R (refer to FIG. 5), and reads an illustration image G1 corresponding to the determined commodity and the commodity name “carrot” from the PLU file F1 to display them on the determination screen 71. Further, the commodity indication section 55 respectively displays the commodity name and the commodity price (unit price) of the determined commodity read from the PLU file F1 in a commodity name display area 81 and a price display area 82. The commodity indication section 55 may display a commodity image (photograph) read from the PLU file F1, instead of the illustration image G1. Alternatively, the commodity indication section 55 may display the commodity name on the determination screen 71, without displaying the illustration image or the photographic image. In this case, that the commodity is determined is notified through the sound output section 165. The sound may be the commodity name pre-registered in association with the commodity, or an electronic sound such as “beep”.

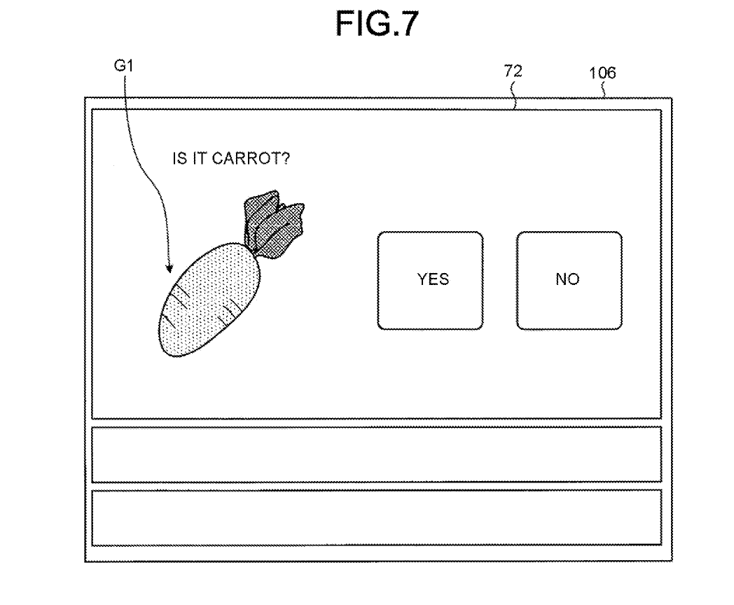

Further, the commodity indication section 55 displays, on the display device 106, a confirmation screen 72 (refer to FIG. 7) which receives a final confirmation operation to confirm whether or not the registered commodity (determined commodity) meeting the condition b is the commodity A photographed by the image capturing section 164.

FIG. 7 is a diagram illustrating an example of the confirmation screen 72. If there is a registered commodity meeting the condition b, the commodity indication section 55 reads an illustration image G1 corresponding to the determined commodity from the PLU file F1 and displays it on the confirmation screen 72. Further, the commodity indication section 55 displays a message, for example, “is it carrot?” or “carrot?” to confirm whether or not the photographed commodity A is the commodity indicated by the illustration image G1 using the commodity name of the determined commodity read from the PLU file F1. Further, buttons such as “YES”, “NO” buttons and the like are arranged on the confirmation screen 72 in such a manner that they can be selected through touch operation on the touch panel 105.

In this way, as the result of the similarity degree determination, the commodity name and the commodity image of the registered commodity (determined commodity) uniquely selected for one commodity A are displayed on the confirmation screen 72, with the one-to-one relation between the commodity A and the registered commodity maintained. Thus, the confirmation screen 72 notifies that the registered commodity meeting the condition b is uniquely determined as the commodity A photographed by the image capturing section 164.

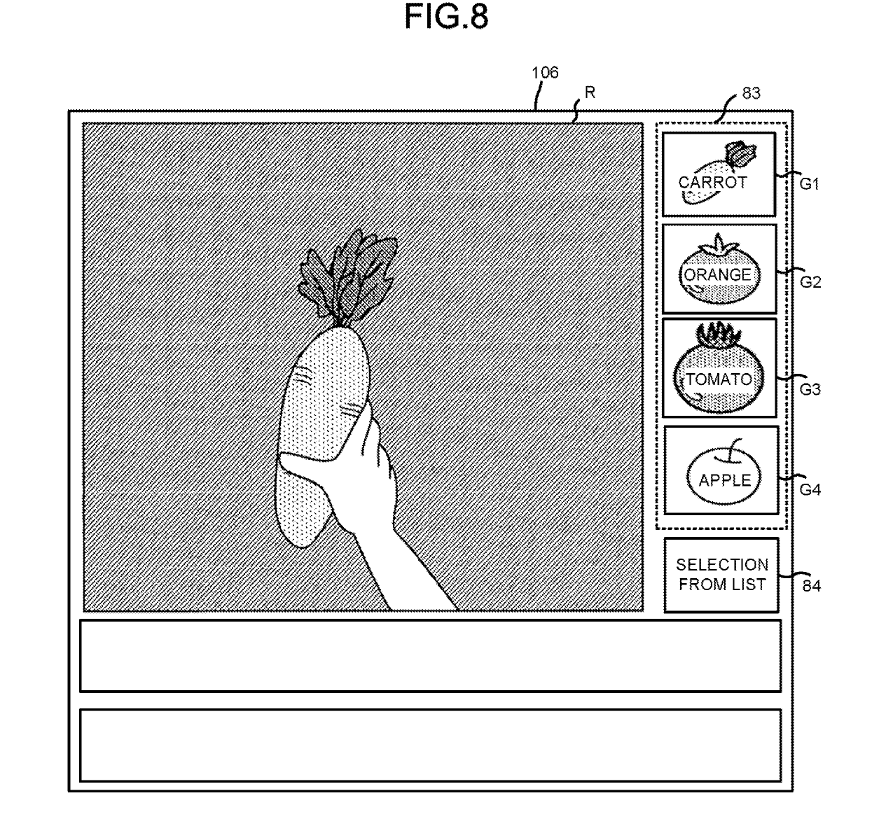

In addition, the commodity indication section 55 displays the information relating to the registered commodity meeting the condition c on the display device 106 as the commodity candidate. More specifically, the commodity indication section 55 reads the illustration images and the commodity names of the registered commodities meeting the condition c from the PLU file F1, and sequentially outputs them to the display device 106 in the descending order of similarity degrees calculated by the similarity degree calculation section 53. The display device 106 sequentially displays the illustration images and the commodity names of the commodity candidates in a commodity candidate indication area 83 (refer to FIG. 8) in the descending order of similarity degree.

FIG. 8 is a diagram illustrating an example of a screen on which the illustration images G1, G2, G3 and G4 of the commodity candidates are respectively displayed. As shown in FIG. 8, the illustration images G1, G2, G3 and G4 of the commodity candidates and each commodity name thereof are displayed in the commodity candidate indication area 83 in the descending order of the similarity degrees of the registered commodities. These illustration images G1, G2, G3 and G4 can be selected by a selection operation on the touch panel 105. Further, a selection button 84 for selecting the commodity A from the commodity list is arranged at the lower portion of the commodity candidate indication area 83, and the commodity selected from the commodity list is processed as the determined commodity described above. In the example shown in FIG. 8, four commodity candidates respectively corresponding to the illustration images G1-G4 are displayed, however, the number of the commodity candidates and the display manner are not limited to this. Further, a commodity image (photograph), instead of the illustration image, may be displayed as the commodity candidate.

Moreover, the commodity indication section 55 displays the information relating to the registered commodities serving as objects of different varieties belonging to the same commodity category meeting the condition d on the display device 106 as the commodity candidates. More specifically, the commodity indication section 55 reads the illustration images and the commodity names of the registered commodities (objects of different varieties belonging to the same commodity category) meeting the condition d from the PLU file F1, and sequentially outputs them to the display device 106 in the descending order of similarity degrees calculated by the similarity degree calculation section 53.

The input reception section 57 receives various input operations corresponding to the display of the display device 106 through the touch panel 105 or the keyboard 107. For example, the input reception section 57 receives an input operation (confirmation operation) indicating the final confirmation that the commodity of the displayed illustration image G1 is the determined commodity based on the selection operation carried out on the confirmation screen 72 (refer to FIG. 7). When the input reception section 57 receives the confirmation operation, the commodity indication section 55 displays the determination screen 71 described above on the display device 106.

The input reception section 57 receives an-operation of selecting any one illustration image from the illustration images G1-G4 (refer to FIG. 8) of the commodity candidates displayed on the display device 106. The input reception section 57 receives the registered commodity indicated by the selected illustration image as the determined commodity for the commodity A. Further, in a case in which the commodity detection section 52 is capable of detecting a plurality of commodities A simultaneously, the input reception section 57 may receive an operation of selecting a plurality of commodity candidates from the commodity candidates. After the input reception section 57 receives the selection operation, the commodity indication section 55 displays the determination screen 71, on which the received commodity candidate is displayed as the determined commodity, on the display device 106.

The information input section 58 inputs information (for example, the commodity ID, the commodity name and the like) indicating the commodity A determined in the aforementioned manner through the connection interface 175.

The information input section 58 may also input the sales volume, which is separately input through the touch panel 105 or the keyboard 107, together with the commodity ID and the like.

The sales registration section 59 carries out the sales registration of the commodity A specified with the commodity ID, using the commodity ID and the sales volume input from the information input section 58. Specifically, the sales registration section 59 records the notified commodity ID and the commodity category, commodity name and unit price specified with the commodity ID in a sales master file together with the sales volume referring to the PLU file F1 to carry out the sales registration.

(Real-Time Recognition Determination Processing on Object Recognition)

Next, the real-time recognition determination processing on the object recognition carried out through the image acquisition section 51, the commodity detection section 52, the similarity degree calculation section 53, the similarity degree determination section 54, the object designation section 91, the determination section 92, the notification section 93 and the additional learning section 94 of the POS terminal 11 is described.

As stated above, the POS terminal 11 adopts the general object recognition in which the category and the like of a target object is recognized (detected) according to the similarity degree obtained by comparing the feature amount of the object extracted from the image data obtained from an image captured by the image capturing section 164 with a prepared reference data (feature amount) in the PLU file F1 serving as a dictionary.

In the general object recognition, the image data obtained from a captured image varies according to the holding manner of the commodity A such as the surface of the commodity A oriented to the reading window 103 (image sensor device), the position of the commodity A, the distance between the image sensor device and the commodity A, and the like. However, an operator has to tray to carry out the sales registration repeatedly in such a manner that he or she changes the surface oriented to the reading window 103, the position, the distance and the like in many ways until he or she empirically masters a suitable holding manner of the commodity A with which the commodity A can be properly recognized in the commodity registration processing described above, which takes too much time and too many troubles.

Thus, the POS terminal 11 according to the present embodiment is capable of notifying the holding manner of the commodity A in the object recognition. That is, the CPU 61 of the POS terminal 11 executes the real-time recognition determination program PR2 to function as the image acquisition section 51, the commodity detection section 52, the similarity degree calculation section 53, the similarity degree determination section 54, the object designation section 91, the determination section 92, the notification section 93 and the additional learning section 94, as shown in FIG. 4. Hereinafter, each section in the real-time recognition determination processing on the object recognition is described.

First, similar to the commodity registration processing, the image acquisition section 51 acquires the frame image captured by the image capturing section 164. Then, similar to the commodity registration processing, the commodity detection section 52, the similarity degree calculation section 53 and the similarity degree determination section 54 function as a recognition module for recognizing the commodity A contained in the image acquired by the image acquisition section 51.

Next, the real-time processing executed by the image acquisition section 51, the commodity detection section 52, the similarity degree calculation section 53 and the similarity degree determination section 54 is described. The image capturing section 164 captures images at 30 fps. Then the image acquisition section 51, the commodity detection section 52, the similarity degree calculation section 53 and the similarity degree determination section 54 execute various processing to calculate similarity degree for each captured frame image. The commodity registration processing relating to the sales registration is repeated for a plurality of frame images by a predetermined time. The commodity registration processing relating to the sales registration uses the similarity degrees of the plurality of accumulated frame images to improve the precision of the commodity recognition. On the other hand, the real-time processing notifies the propriety of the holding manner of the commodity using the similarity degree of one frame image captured at 30 fps. In this way, the present embodiment can realize notification in real-time.

In a case in which the commodity A cannot be detected, the commodity detection section 52, the similarity degree calculation section 53 and the similarity degree determination section 54 abandon the processing and notifies the later-described notification section 93 of the message. A case in which the entire or part of the commodity A is not photographed, or a case in which the commodity A is shielded by a hand holding the commodity A, and the like are given as the above-described case of failure in commodity detection.

The object designation section 91, functioning as a selection module, selects a target commodity on a real-time recognition determination from the PLU file F1 serving as a prepared dictionary. The object designation section 91 enables the operator to select a commodity name of an object on the real-time recognition determination from the registered commodity list stored in the PLU file F1 to designate the target commodity on the real-time recognition determination.

The image capturing speed is not limited to 30 fps. The number of the frame images used in the calculation of the similarity degree, which is not limited to one, may be two or more.

The determination section 92 determines the propriety of the holding manner according to the ranking of the commodity A selected by the object designation section 91 in the recognition result obtained at the time the commodity detection section 52, the similarity degree calculation section 53 and the similarity degree determination section 54 function as the recognition module for recognizing the commodity A contained in the image. At this time, the determination section 92 carries out determination at three stages according to the ranking in which the target commodities are ranked in the magnitude of similarity degree. The number of stages of the determination may be two, four or more.

Next, the three stages of the determination by the determination section 92 are described in detail.

First, a case in which the ranking in the similarity degrees of the registered commodities selected as the targets of the real-time recognition determination processing is high is described. In a case in which at least one of two conditions that the ranking is the first, or it is a determined commodity is met, the determination section 92 determines that the ranking in the similarity degree of the selected registered commodity is high.

Next, a case in which the ranking in the similarity degrees of the registered commodities selected as the targets of the real-time recognition determination processing is medium is described. In a case of candidate commodities other than the first-ranking candidate commodity, that is, the ranking thereof are from a second to a fourth, the determination section 92 determines that the ranking in the similarity degree of the selected registered commodity is medium. The candidate commodities other than the first-ranking candidate commodity are not limited to the candidate commodities ranked from the second to the fourth, and it may include a candidate commodity ranked at a fifth or below.

Next, a case in which the ranking in the similarity degrees of the registered commodities selected as the targets of the real-time recognition determination processing is low is described. In a case in which the similarity degree is smaller than that of the commodity candidate, that is, the ranking is below a fifth, the determination section 92 determines that the ranking in the similarity degree of the selected registered commodity is low. Alternatively, in a case in which the commodity detection section 52 cannot detect the commodity A and the processing for calculating the ranking is abandoned, the determination section 92 determines that the ranking in the similarity degree of the selected registered commodity is low.

The notification section 93 notifies the determination result of the determination section 92. Specifically, the notification section 93 displays a screen according to the determination result of the determination section 92 to give a notification.

The notification section 93 notifies the guidance information stored in the PLU file F1 in association with the commodity A. In this way, the operator can hold the commodity A over the image capturing section 164, taking the important point for each feature of the commodity to be photographed into consideration.

The additional learning section 94 additionally learns (additionally registers) the reference data (feature amount) of the commodity pre-registered in the PLU file F1. Specifically, the additional learning section 94 captures the image serving as the reference data (feature amount) again and acquires them to update the data. The reference data (feature amount) can be stored for a certain amount. If the reference data (feature amount) reaches the certain amount, the reference data (feature amount) is sequentially deleted from the old one, or is deleted randomly.

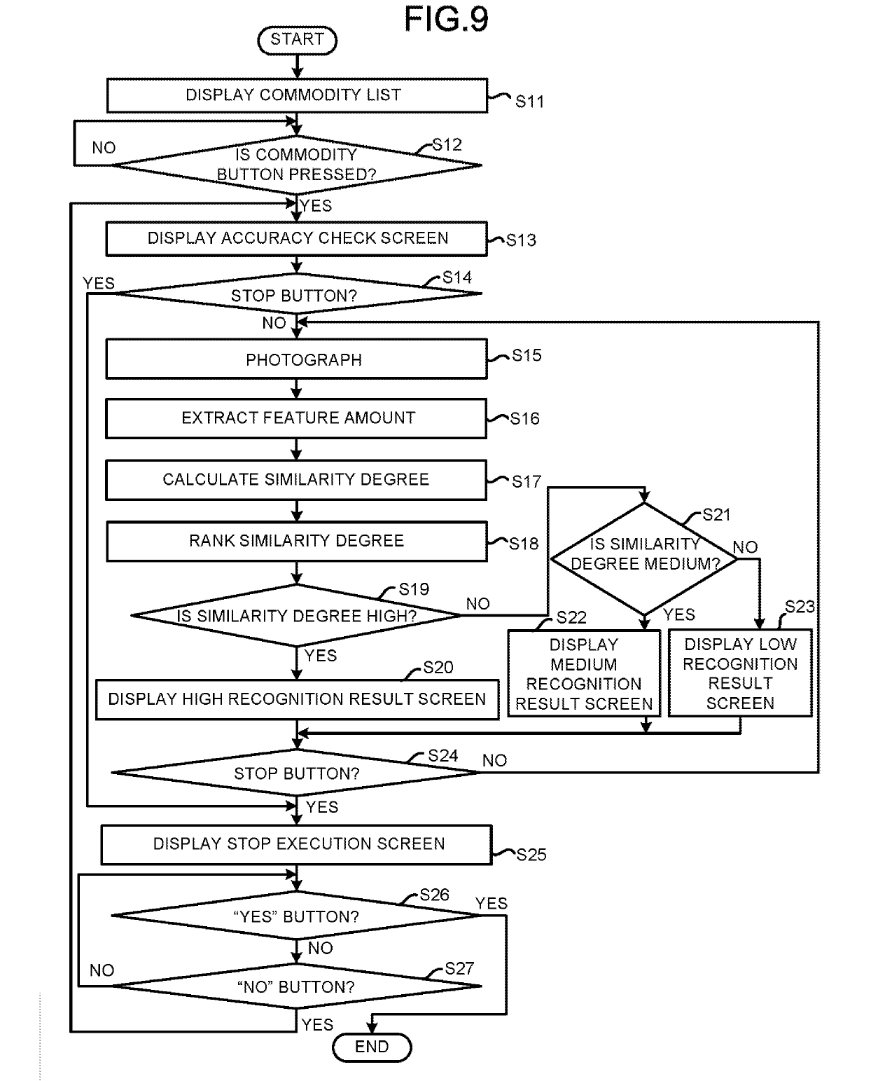

Next, the operation of the checkout system 1 in the real-time recognition determination processing is described in detail. FIG. 9 is a flowchart illustrating the real-time recognition determination processing executed by the checkout system 1. As a presupposition, the real-time recognition determination program PR2 is started.

As shown in FIG. 9, the CPU 61 of the POS terminal 11 (object designation section 91) displays a commodity selection screen (not shown) (ACT S11). The commodity selection screen displays a list of registered commodities in the dictionary for the operator to select a commodity to be subject to the real-time recognition determination processing from the registered commodities. The operator can select the commodity A to be subject to the real-time recognition determination processing by pressing a commodity button displayed on the commodity selection screen.

Sequentially, the CPU 61 of the POS terminal 11 (object designation section 91) determines whether or not the commodity button is pressed (ACT S12). If the commodity button is not pressed (NO in ACT S12), the CPU 61 of the POS terminal 11 (object designation section 91) waits for in ACT S12.

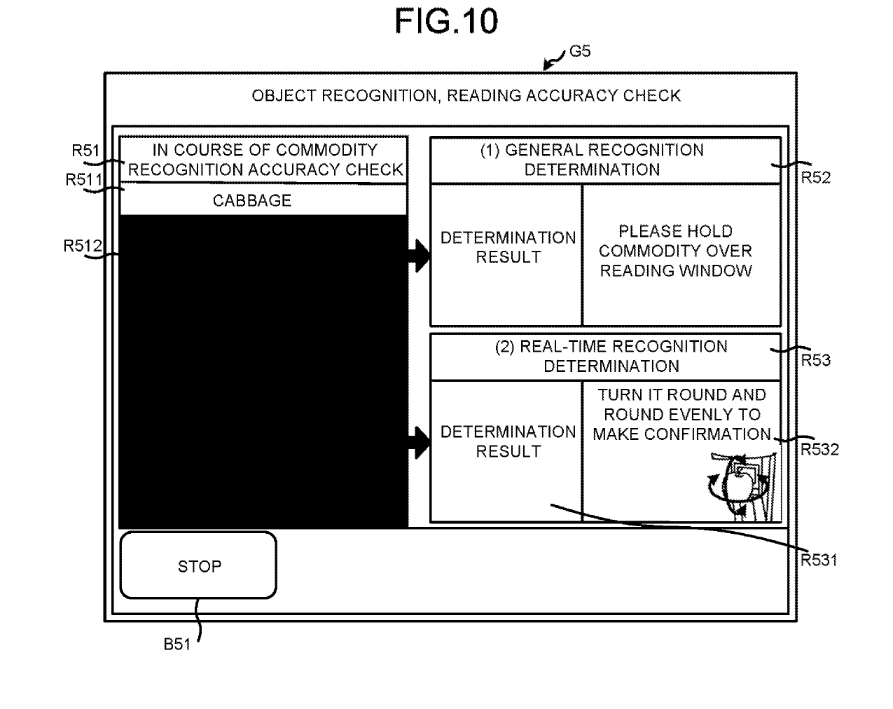

If the commodity button is pressed (YES in ACT S12), the CPU 61 of the POS terminal 11 displays an accuracy check screen G5 (refer to FIG. 10) (ACT S13).

FIG. 10 is a diagram illustrating an example of the accuracy check screen G5. The accuracy check screen G5 displays the status and the determination result of the real-time recognition determination processing. The accuracy check screen G5 includes, if roughly classified, a commodity display area R51, a general recognition determination area R52, a real-time recognition determination area R53 and a stop button B51.

The commodity display area R51 displays an image which is obtained by the image capturing section 164 by photographing a target commodity of the real-time recognition determination processing and acquired by the image acquisition section 51. The commodity display area R51 includes a commodity name area R511 and an image capturing area R512. The commodity name area R511 displays the commodity name of a preselected target commodity to be subject to the real-time recognition determination processing. The image capturing area R512 displays the image captured by the image capturing section 164. With the image displayed in the image capturing area R512, the operator can confirm that the commodity is being photographed by the image capturing section 164.

The general recognition determination area R52 displays a determination result of a commodity recognition accuracy check function for checking the accuracy of the reference data (similarity degree).

The real-time recognition determination area R53 displays a recognition result of a single frame so that the recognition result is displayed in real time. The real-time recognition determination area R53 includes a determination result area R531 and a message area R532. The determination result area R531 displays the propriety of the holding manner of the commodity A as the result of the real-time recognition determination. The message area R532 displays the important point or matters to be attended to for each feature of a photographed commodity according to the guidance information stored in the PLU file F1 in association with the commodity A. The stop button B51 is pressed when desiring to stop the real-time recognition determination processing.

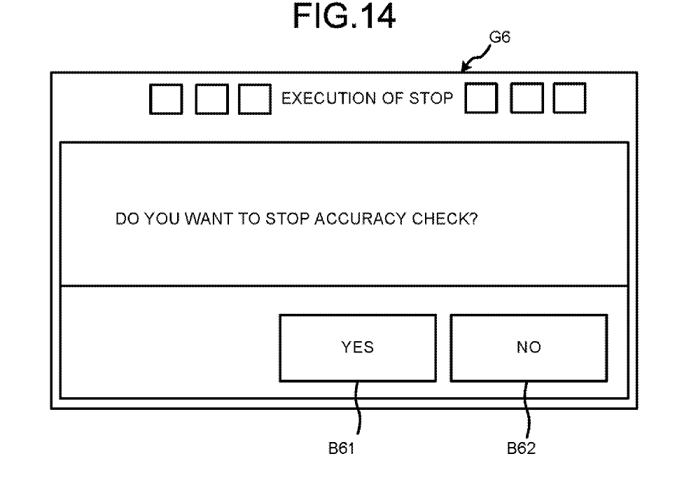

Then the CPU 61 of the POS terminal 11 determines whether or not the stop button B51 arranged on the accuracy check screen G5 is pressed (ACT S14). If the stop button B51 is pressed (YES in ACT S14), the CPU 61 of the POS terminal 11 displays a stop execution screen G6 (refer to FIG. 14) (ACT S25).

On the other hand, if the stop button B51 arranged on the accuracy check screen G5 is not pressed (NO in ACT S14), the CPU 61 of the POS terminal 11 (image acquisition section 51) captures a frame image with the image capturing section 164 and acquires the captured frame image (ACT S15).

The CPU 61 of the POS terminal 11 (commodity detection section 52) extracts the feature amount of the commodity A (ACT S16). The CPU 61 of the POS terminal 11 (similarity degree calculation section 53) calculates the similarity degree of the registered commodity for each frame image (ACT S17). Then the CPU 61 of the POS terminal 11 (similarity degree determination section 54) creates a ranking in which the registered commodities are ranked in the magnitude of similarity degree (ACT S18).

Next, the CPU 61 of the POS terminal 11 (determination section 92) determines whether or not the ranking in the similarity degree of the registered commodity selected as the target of the real-time recognition determination processing is high (ACT S19). Herein, it can be determined that the ranking is high if at least one of the following two conditions is met: the ranking in the similarity degree of the selected registered commodity is the first, or it is a determined commodity having a high similarity degree.

If the ranking in the similarity degree of the selected registered commodity is high (YES in ACT S19), the CPU 61 of the POS terminal 11 (notification section 93) displays a high recognition result screen G51 in the real-time recognition determination area R53 (ACT S20).

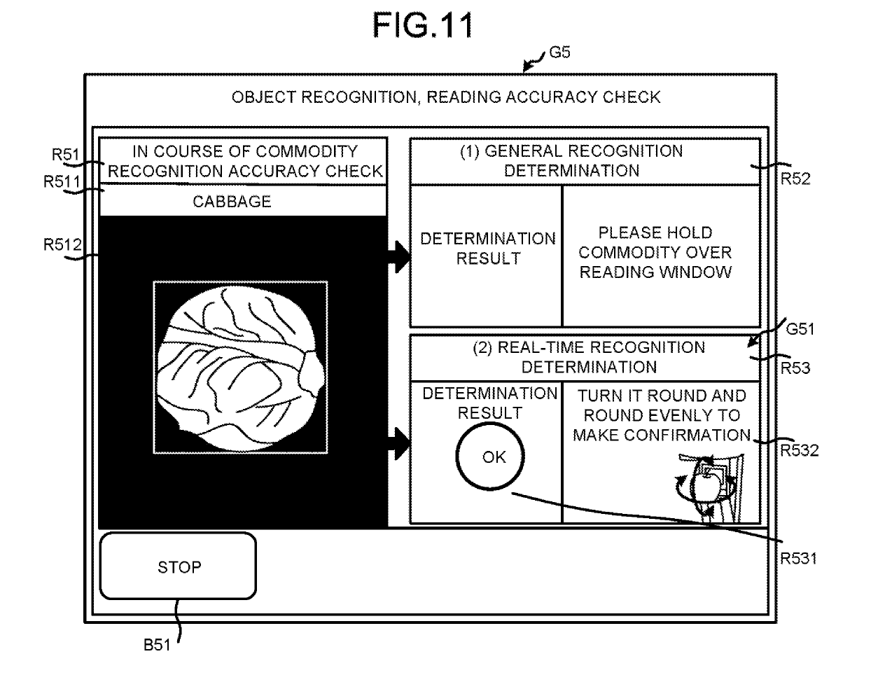

FIG. 11 is a diagram illustrating an example of the high recognition result screen G51. The high recognition result screen G51 displays a message indicating that the ranking in the similarity degree of the selected registered commodity is high. The high recognition result screen G51 displays a message “determination result OK” indicating that the ranking in the similarity degree of the selected registered commodity is high in the determination result area R531. In this way, the operator can be aware which part (surface) of the commodity A should be photographed by the image capturing section 164 to recognize the commodity A. Further, the operator can be aware which position the commodity A should be held to the reading window 103 and then photographed by the image capturing section 164 to properly recognize the commodity A.

Guidance information “turn it round and round evenly to make confirmation” is displayed in the message area R532 to instruct the operator to try to carry out recognitions on various parts (surfaces) of the commodity A so that the operator learns the holding manner through which the commodity A can be recognized.

If the ranking in the similarity degree of the selected registered commodity is not high (NO in ACT S19), the CPU 61 of the POS terminal 11 (determination section 92) determines whether or not the ranking in the similarity degree of the registered commodity selected as the target of the real-time recognition determination processing is medium (ACT 521) Herein, the medium-ranking refers to a commodity candidate other than the first-ranking candidate commodity. Specifically, the ranking in the similarity degree of the selected registered commodity is from the second to the fourth.

If the ranking in the similarity degree of the selected registered commodity is medium (YES in ACT S21), the CPU 61 of the POS terminal 11 (notification section 93) displays a medium recognition result screen G52 in the real-time recognition determination area R53 (ACT S22).

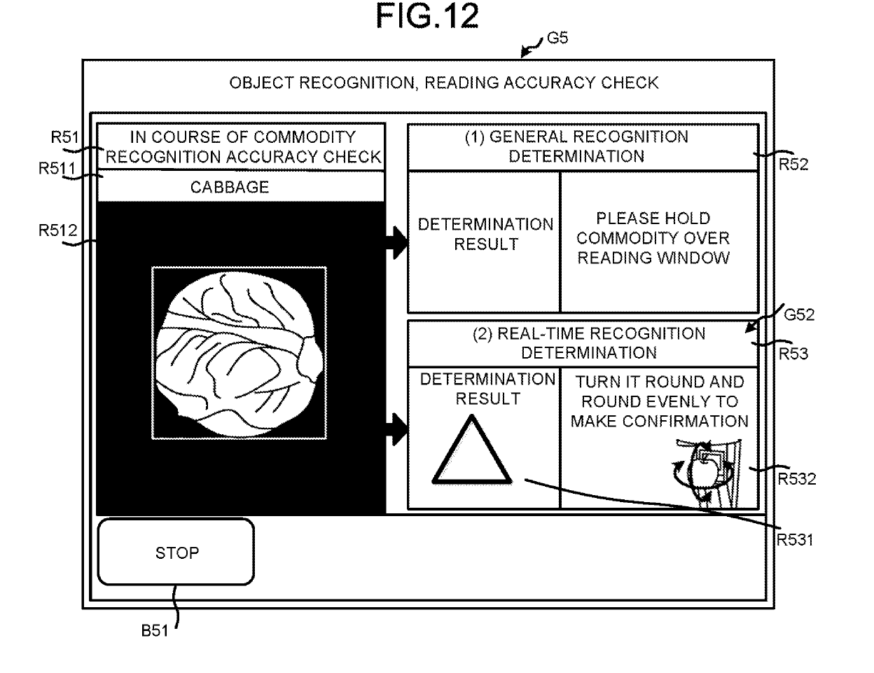

FIG. 12 is a diagram illustrating an example of the medium recognition result screen G52. The medium recognition result screen G52 displays a message indicating that it is a commodity candidate other than the commodity candidate having the highest similarity degree, and that the ranking in the similarity degree of the selected registered commodity is medium. The medium recognition result screen G52 displays a mark “Δ” indicating that the ranking in the similarity degree of the selected registered commodity is medium in the determination result area R531. Further, the medium recognition result screen G52 displays the guidance information similar to that displayed in the high recognition result screen G51 in the message area R532.

If the ranking in the similarity degree of the selected registered commodity is not medium (NO in ACT S21), the CPU 61 of the POS terminal 11 (notification section 93) determines that the ranking in the similarity degree of the selected registered commodity is low, and displays a low recognition result screen G53 in the real-time recognition determination area R53 (ACT S23).

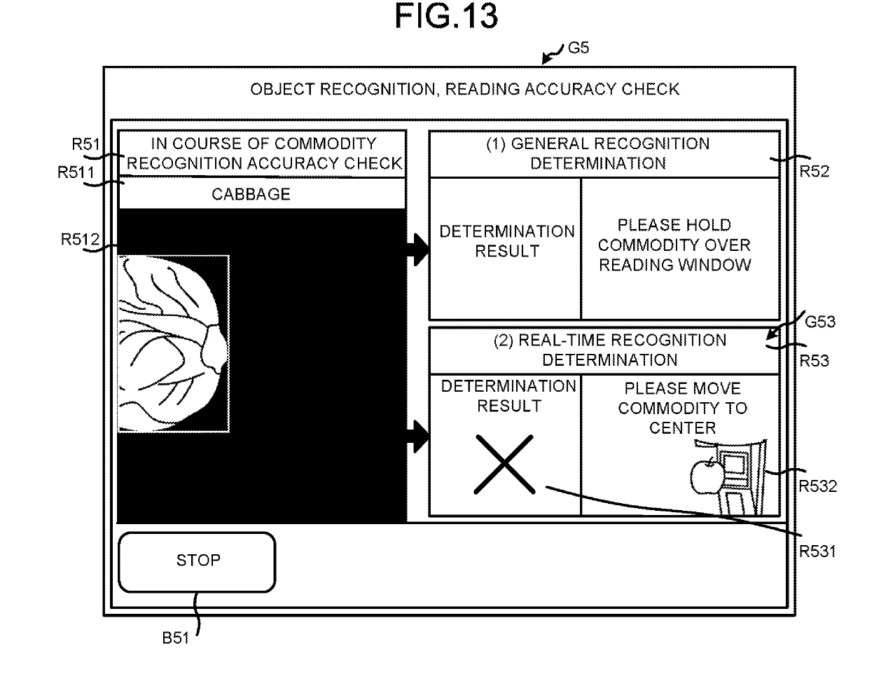

FIG. 13 is a diagram illustrating an example of the low recognition result screen G53. The low recognition result screen G53 displays a message indicating that the similarity degree is smaller than that of the commodity candidate, and the ranking in the similarity degree of the selected registered commodity is low. Further, the low recognition result screen G53 is displayed in a case in which the commodity detection section 52 cannot detect the commodity A and the processing for calculating the ranking is abandoned. The low recognition result screen G53 displays a mark “X” indicating that the ranking in the similarity degree of the selected registered commodity is low in the determination result area R531.

Further, in a case in which the ranking in the similarity degree of the selected registered commodity is low, the low recognition result screen G53 displays guidance information stored in the PLU file F1 in the message area R532.

In a case in which the processing for calculating the ranking is abandoned, the low recognition result screen G53 displays measures corresponding to the reason for abandon in the message area R532, instead of the guidance information. In the image capturing area R512 shown in FIG. 13, the left side of a cabbage (commodity A) is not photographed. Thus, the low recognition result screen G53 displays a message “please move commodity to center” in the message area R532.

Next, the CPU 61 of the POS terminal 11 determines whether or not the stop button B51 is pressed (ACT S24). If the stop button B51 is not pressed (NO in ACT S24), the CPU 61 of the POS terminal 11 executes the processing in ACT S15 again.

On the other hand, if the stop button B51 is pressed (YES in ACT S24), the CPU 61 of the POS terminal 11 executes the processing in ACT S25 to display the stop execution screen G6 (ACT S25).

FIG. 14 is a diagram illustrating an example of the stop execution screen G6. The stop execution screen G6 is used to confirm whether or not the real-time recognition determination processing is terminated if the stop button B51 is pressed. Thus, the stop execution screen G6 displays a message “do you want to stop accuracy check?”. The stop execution screen G6 includes a “YES” button B61 and a “NO” button B62. The “YES” button B61 is pressed if desiring to terminate the real-time recognition determination processing. The “NO” button B62 is pressed if desiring to cancel the termination of the real-time recognition determination processing.

Next, the CPU 61 of the POS terminal 11 determines whether or not the “YES” button 561 displayed on the stop execution screen G6 is pressed (ACT S26). If the “YES” button B61 is not pressed (NO in ACT S26), the CPU 61 of the POS terminal 11 determines whether or not the “NO” button B62 displayed on the stop execution screen G6 is pressed (ACT S27).

If the “NO” button B62 is not pressed (NO in ACT S27), the CPU 61 of the POS terminal 11 executes the processing in ACT S26 again. On the other hand, if the “NO” button 562 is pressed (YES in ACT S27), the CPU 61 of the POS terminal 11 executes the processing in ACT S13 again.

On the other hand, if the “YES” button B61 displayed on the stop execution screen G6 is pressed (YES in ACT S26), the CPU 61 of the POS terminal 11 terminates the real-time recognition determination processing.

As stated above, in accordance with the present embodiment, the information processing apparatus (POS terminal) is equipped with the object designation section 91 for selecting the target commodity of the real-time recognition determination processing from the PLU file F1 serving as a dictionary in which the feature amount for recognizing the commodity A is registered. Further, the apparatus is equipped with the image capturing section 164 for photographing the commodity A held to the reading window 103. The commodity A contained in the image captured by the image capturing section 164 is recognized using the similarity degree by the commodity detection section 52, the similarity degree calculation section 53 and the similarity degree determination section 54 functioning as the recognition module. The determination section 92 determines the propriety of the holding manner of the commodity oriented to the reading window according to the ranking of the commodity A selected by the object designation section 91 in the recognition result. Then the notification section 93 notifies the determination result of the determination section 92. Thus, according to the present embodiment, the propriety of the manner of holding the commodity A oriented to the reading window (image capturing section 164) can be notified.

While certain embodiments have been described, these embodiments have been presented by way of example only, and are not intended to limit the scope of the present invention. Indeed, the novel embodiments may be embodied in a variety of other forms; furthermore, various omissions, substitutions and variations thereof may be devised without departing from the spirit of the present invention. The accompanying claims and their equivalents are intended to cover such forms and modifications as would fall within the scope and spirit of the present invention.

Further, it is exemplified in the embodiment described above that the POS terminal 11 is described as an example of the information processing apparatus. However, the information processing apparatus is not limited to the POS terminal 11. For example, the information processing apparatus may be a personal computer, a tablet terminal and the like. In this case, an image capturing device such as a scanner and the like connected with the personal computer or the tablet terminal is required to capture the image of a commodity.

It is exemplified in the embodiment described above that the CPU 61 of the POS terminal 11 serving as the information processing apparatus has functions of the image acquisition section 51, the commodity detection section 52, the similarity degree calculation section 53, the similarity degree determination section 54, the commodity indication section 55, the input reception section 57, the information input section 58, the sales registration section 59, the object designation section 91, the notification section 93 and the additional learning section 94. However, these functions may be included in a device other than the CPU 61 of the POS terminal 11. For example, all or part of these functions may be included in the CPU 161 of the commodity reading apparatus 101.

It is exemplified in the embodiment described above that the reference data is described as the feature amount, however, the reference data may be a captured commodity image (reference image).

Further, in the embodiment stated above, the present invention is applied to the checkout system 1 consisting of the POS terminal 11 and the commodity reading apparatus 101 as a store system, however, it is not limited to this, and it may also be applied to a single apparatus comprising all the functions of the POS terminal 11 and the commodity reading apparatus 101. As an apparatus comprising all the functions of the POS terminal 11 and the commodity reading apparatus 101, a self-checkout POS terminal (hereinafter referred to as a self-checkout POS) installed in a store such as a supermarket and the like is known.

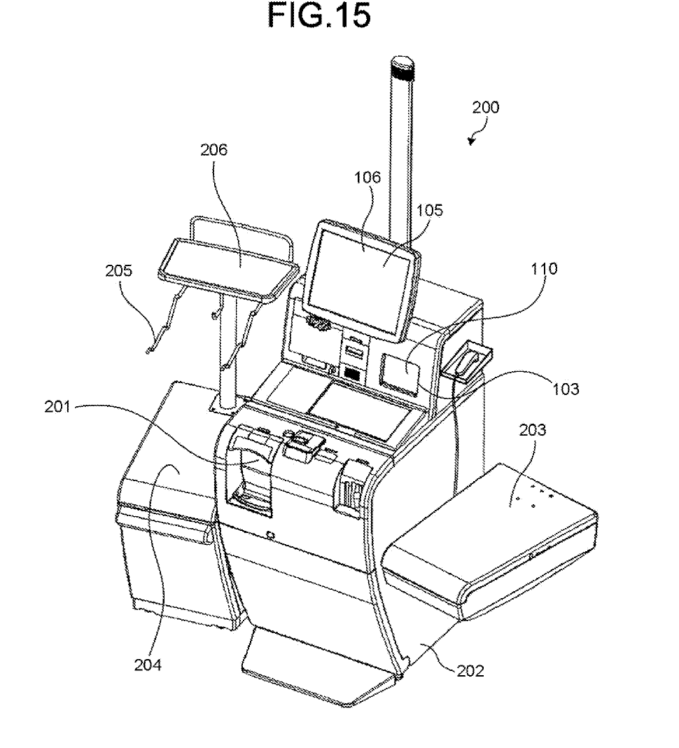

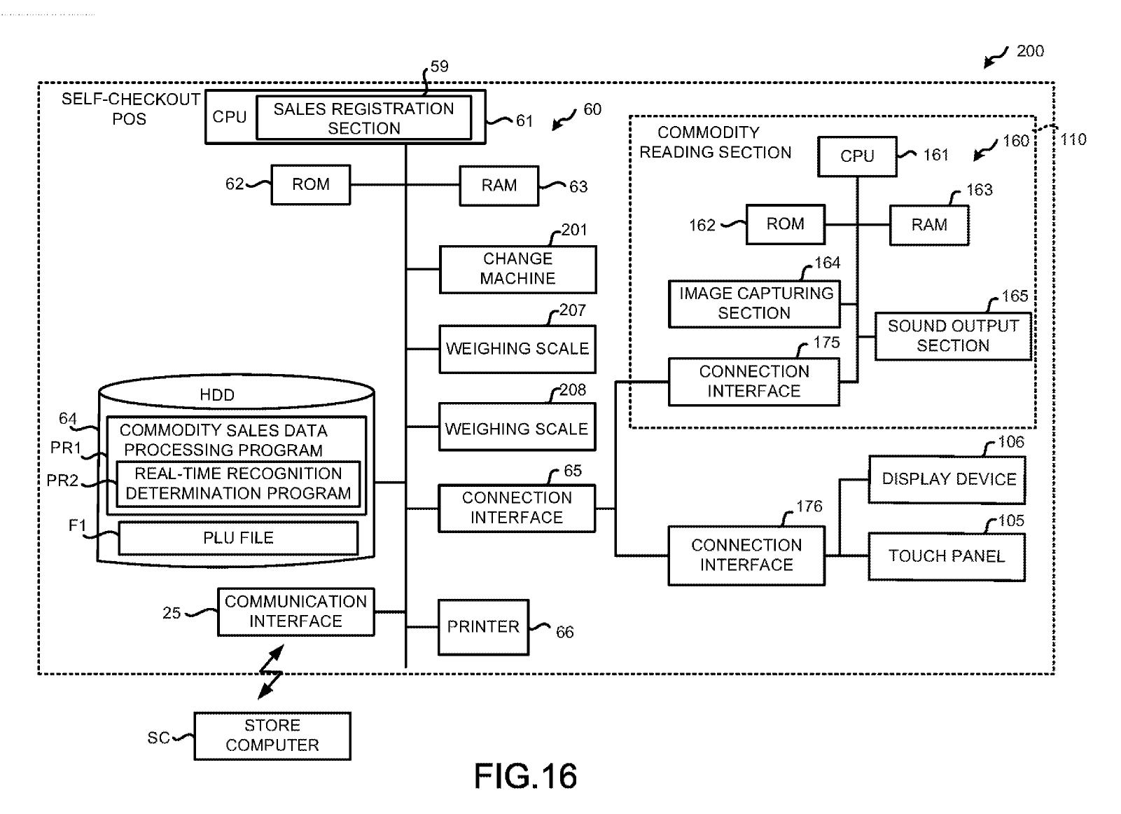

FIG. 15 is a perspective view illustrating the external constitution of the self-checkout POS 200, and FIG. 16 is a block diagram illustrating the hardware constitution of the self-checkout POS 200. Hereinafter, the same numerals are applied to the components similar to that in FIG. 1 and FIG. 2, and therefore the detailed descriptions thereof are not repeated. As shown in FIG. 15 and FIG. 16, the self-checkout POS 200 comprises a display device 106 having a touch panel 105 on the surface thereof and a commodity reading section 110 which captures a commodity image to recognize (detect) the category of the commodity in a main body 202 thereof.

The display device 106 may be, for example, a liquid crystal display. The display device 106 displays a guidance screen for providing customers with a guidance for the operation of the self-checkout POS 200, various input screens, a registration screen for displaying the commodity information captured by the commodity reading section 110, and a settlement screen on which a total amount of the commodities, a deposit amount, a change amount, and various payment methods are displayed to select a desired payment method.

The commodity reading section 110 captures a commodity image through the image capturing section 164 when the customer holds the code symbol attached to the commodity to the reading window 103 of the commodity reading section 110.

Further, the self-checkout POS 200 includes a commodity placing table 203 for placing a shopping basket (unsettled basket) in which an unsettled commodity is put at the right side of the main body 202, and another commodity placing table 204 for placing a shopping basket (settled basket) in which a settled commodity is put after the sales registration thereof is executed at the left side of the main body 202. A bag hook 205 for hooking a bag for placing the settled commodities therein and a temporary placing table 206 for placing the settled commodities temporarily before the settled commodities are put into a bag are also provided at the left side of the main body 202. The commodity placing tables 203 and 204 are equipped with weighing scales 207 and 208 respectively, and are therefore capable of confirming whether or not the weight of commodity (commodity taken out of the unsettled basket and commodity put into the settled basket) is the same before and after a settlement of the commodity is executed.

Further, a change machine 201 for receiving bill for settlement and discharging bill as change is arranged in the main body 202 of the self-checkout POS 200.

In a case in which the self-checkout POS 200 having such constitutions as described above is applied to the store system, the self-checkout POS 200 functions as an information processing apparatus.

Further, in the embodiment above, the programs executed by each apparatus are pre-installed in the storage medium (ROM or storage section) of each apparatus, however, the present invention is not limited to this, the programs may be recorded in a computer-readable recording medium such as CD-ROM, flexible disk (FD), CD-R, DVD (Digital Versatile Disk) in the form of installable or executable file. Further, the storage medium, which is not limited to a medium independent from a computer or an incorporated system, further includes a storage medium for storing or temporarily storing the downloaded program transferred via an LAN or the Internet.

In addition, the programs executed by each apparatus described in the embodiment above may be stored in a computer connected with a network such as the Internet to be provided through a network download or distributed via a network such as the Internet.

What is claimed is:

1. An information processing apparatus comprising:
a selection module configured to select a target object from a storage section in which feature amounts for recognizing an object are stored for a plurality of objects;
an image capturing module configured to photograph an object held to the image capturing module to capture an image of the object;
a recognition module configured to compare the feature amount of the object stored in the storage section with the feature amount of the object contained in the image captured by the image capturing module to recognize the object photographed by the image capturing module;
a determination module configured to determine the propriety of a holding manner of the object according to the ranking of the object selected by the selection module in the recognition result of the recognition module; and
a notification module configured to notify a determination result of the determination module.

2. The information processing apparatus according to claim 1, wherein the notification module notifies, for each frame image of the object, the propriety of the manner of holding the object over the image capturing module, which is derived from the comparison between the object selected by the selection module and the recognition result of the recognition module.

3. The information processing apparatus according to claim 1, wherein the notification module notifies the propriety of the manner of holding the object over the image capturing module in a plurality of stages.

4. The information processing apparatus according to claim 2, wherein the notification module notifies the propriety of the manner of holding the object over the image capturing module in a plurality of stages.

5. The information processing apparatus according to claim 1, wherein the notification module displays a message relating to the propriety of the manner of holding the object over the image capturing module.

6. A store system comprising:
a selection module configured to select a target object from a storage section in which feature amounts for recognizing an object are stored for a plurality of objects;
an image capturing module configured to photograph an object held to the image capturing module to capture an image of the object;
a recognition module configured to compare the feature amount of the object stored in the storage section with the feature amount of the object contained in the image captured by the image capturing module to recognize the object photographed by the image capturing module;
a determination module configured to determine the propriety of a holding manner of the object according to the ranking of the object selected by the selection module in the recognition result of the recognition module; and
a notification module configured to notify a determination result of the determination module; and
a sales registration module configured to recognize a commodity photographed by the image capturing module using the feature amount for recognizing the object and execute sales registration processing.

7. A method for recognizing an object by an information processing apparatus which comprises a storage section, an image capturing module, a selection module, a determination module and a recognition module, including:
selecting a target object from the storage section in which feature amounts for recognizing an object are stored for a plurality of objects;
photographing a held object to capture an image thereof;
comparing the feature amount of the object stored in the storage section with the feature amount of the object contained in the image captured by the image capturing module to recognize the object photographed by the image capturing module;
determining the propriety of a holding manner by the determination module according to a ranking of the object selected by the selection module in the recognition result of the recognition module; and
notifying a determination result of the determination module.
